(19) United States
(12) Patent Application Publication
(10) Pub. No.: US 2001/0034705 A1
(43) Pub. Date: Oct. 25, 2001

(54) Payment-based systems for internet music

(76) Inventors: Geoffrey B. Rhoads, West Linn, OR (US); Reed R. Stager, Portland, OR (US)

Correspondence Address: DIGIMARC CORPORATION, 19652 SW 72ND AVENUE, SUITE 100, TUALATIN, OR, 97062, US

(21) Appl. No.: 09/800,094

(22) Filed: Mar. 5, 2001

Related U.S. Application Data
(63) Continuation-in-part of application No. 09/337,590, filed on Jun. 21, 1999.
(63) Continuation-in-part of application No. 09/690,773, filed on Oct. 17, 2000.
(60) Provisional application No. 60/134,782, filed on May 19, 1999.

(51) Int. Cl. G06F 17/60; H04K 1/00; H04L 9/00

(52) U.S. Cl. 705/39; 705/52

(57) ABSTRACT

One of the impediments to success of fee-based music downloads on the internet has been the fee. Not the amount, but the logistics. Credit cards have high transaction costs, making them unsuitable for purchases of, e.g., less than five dollars. Perhaps more importantly, much of the target audience for downloadable music is teenagers, who don't have credit cards. To redress this problem, digital tokens can be used to pay for downloaded music (or other content, such as videos, on-line games, etc.). These tokens can be exchanged by email and can be acquired in a number of teen-friendly manners, including by pre-arranged periodic disbursement (e.g., from a bank, arranged by a parent as a form of monthly allowance), given away as part of product promotions, exchanged between friends, etc.

### RELATED APPLICATION DATA

The present application is a continuation-in-part of application Ser. No. 09/337,590, filed Jun. 29, 1999, which claims priority benefit to Ser. No. 60/134,782, filed May 19, 1999. This application is also a continuation-in-part of application Ser. No. 09/690,773, filed Oct. 17, 2000.

### BACKGROUND AND SUMMARY OF THE INVENTION

One of the impediments to success of fee-based music downloads on the internet has been the fee. Not the amount, but the logistics. Credit cards have high transaction costs, making them unsuitable for purchases of, e.g., less than five dollars. Perhaps more importantly, much of the target audience for downloadable music is teenagers, who don't have credit cards.

In accordance with one embodiment of the present invention, digital tokens are used to pay for downloaded music (or other content, such as videos, on-line games, etc.). These tokens can be acquired in a number of teen-friendly manners.

The foregoing and additional features and advantages of the present invention will be more readily apparent from the following detailed description.

### DETAIL DESCRIPTION

In application Ser. No. 09/337,590, the present assignee detailed how pseudo-random numbers can serve as one-time money tokens in a variety of contexts, including payment for on-line content. The pseudo-random numbers can be issued by banks or by other institutions.

Such money tokens can be employed in a variety of content delivery applications. One is peer-to-peer systems such as Napster and the like. Another is traditional client-server architectures, such as are used by various on-line music vendors. In all such systems, the user's software can solicit payment for the content before a download is commenced. (Desirably, the payment would not actually become effective until the download is successfully completed.)

In an exemplary embodiment, the user interface (UI) solicits the user to provide the payment. In some embodiments, the UI can provide a virtual wallet or purse, in which coinage is stored, and from which money can be dragged-and-dropped by the user into a coin slot or the like to pay for the music. A generic coin icon can be manipulated by the user to move over different parts of a screen interface, and the value changes in accordance with its position (e.g., if positioned over a garage band selection, a fee of 1 cent may be display; if positioned over a hot new release, a fee of 15 cents may be displayed). By dropping the virtual coin onto a selection, the user signals the intention to make the specified payment. Alternatively, a text box can appear, permitting the user to type in the amount of money to be deposited. Or, the UI can have a single button or the like that authorizes payment of the requested amount from a local money repository. A variety of other such payment interfaces will be apparent to the reader.

When the user performs such action (and following appropriate verification), a corresponding payment confirmation is sent to a central server, which in turn authorizes download of the requested content. At that time, or later, the user's repository of digital money is debited. (Some systems may debit the finds immediately, and later refund the debited amount if the download proves incomplete or is otherwise unsuccessful.)

The payment interface can take the form of shell software that is ancillary to the underlying media player or e-distribution software (e.g., music software from Napster, Liquid Audio, MP3, etc.). Thus, the shell governs use of a music platform or environment application, but complex integration with the application is not required.

In some download systems, some content may be free—either for being public domain, non-copyrighted, or copyrighted-but free. Accordingly, in such systems there is desirably data associated with each available item of content that indicates whether a charge should be assessed and, if so, how much. This information can be “out-of-band”(i.e., not in the bits comprising the music or other content data itself). Header information is one example of such “out-of-band” association. Or the information can be integral (“in-band”) with the content, as by digital watermarking. (An exemplary digital watermarking system is shown in application Ser. No. 09/503,881, filed Feb. 14, 2000.) The information itself can be literally encoded, or a link can be encoded, with the link pointing to a repository (e.g., database location) and which the information is available.

As noted, the pseudo-random numbers can be acquired through a bank. Numbers may also be purchased from other sources, such as convenience stores, or school stores.

In one such system, payment is tendered to the bank (over the counter, by credit card, by electronic account debit, etc), and the bank emails a file containing the numbers to a specified address. By such arrangement, for example, a parent may arrange for a bank to send his children five dollars per month of money tokens that they can spend on-line as part of their allowance. Other possibilities by which juveniles can obtain money coins (MCs) include:

their local bank e-mails MCs right out of their account;

they can easily buy them with a credit card or set up a “demand account” where either regular MCs are sent periodically or a simple e-mail can fetch a bunch;

they can pick them up with their PDA's at their regular music store;

they come packaged with stuff (CD's, DVD's, promotional e-mails, available on websites, etc.);

friends can e-mail MCs to friends;

they can be e-mailed to specific set-top-boxes or other “internet enabled” media consumption devices;

In addition to electronic distribution, MCs can also be provided on storage media, such as diskette.

Money coins may be branded by the issuer or distributor. Thus, a Coke promotion can include the distribution of Coke-branded tokens.

Applications Ser. Nos. 09/690,773 and 09/571,422 detail how stickers, cards, and other objects can be encoded with steganographic information. When presented to a webcam, such an object can instigate essentially any computer action.

In one embodiment of the present invention, stickers or cards are sold or otherwise provided to teens (e.g., from machines, from convenience stores, given away as premiums, etc.), and can be redeemed for online payment tokens. Redemption is effected by showing the card or sticker to a web-cam.

More particularly, an application executing on the user's computer processes the image data provided by the webcam and decodes the steganographically-encoded payload. This payload data is then relayed to a remote computer, such as the Digimarc MediaBridge server. This remote computer, in turn, provides return data back to the user's computer. In some embodiments, this return data can be an allotment of digital money tokens that are then stored on the user's computer for later use. (A five dollar sticker may return 16 virtual quarters, five virtual dimes, and ten virtual nickels, or 500 virtual pennies, etc.) Or the return data can be the address of yet another computer server. In the latter case, the user's computer automatically links to the specified address. That server, in turn, provides the digital money tokens for storage on the user's computer.

It will be recognized that payment mechanisms other than the preferred pseudo-random number arrangement can alternatively be employed.

Naturally, the technology detailed above can be used in conjunction with systems that also employ digital watermarking, robust hashing, and the like to effect copyright notification, copy control, linking from music to associated web resources, monitoring, asset management, etc., etc. (A few such applications are detailed in pending application Ser. No. 09/574,726).

To provide a comprehensive disclosure without unduly lengthening this specification, applicants incorporate by reference the patents and patent applications cited above.

In view of the wide variety of embodiments to which the principles and features discussed above can be applied, it should be apparent that the detailed embodiments are illustrative only and should not be taken as limiting the scope of the invention. Rather, we claim as our invention all such modifications as may come within the scope and spirit of the following claims and equivalents thereof.

We claim:

1. A method comprising:
issuing a periodic allowance to a juvenile, said allowance comprising an allotment of digital money tokens; and
charging a parent of said juvenile for said allowance.

2. The method of claim 1 that further includes spending at least some of said digital money tokens as compensation for music delivered to the juvenile over an electronic network.

3. The method of claim 1 wherein each of the digital money tokens comprises a pseudorandom number.
